(19) United States
(12) Patent Application Publication
(10) Pub. No.: US 2016/0119820 A1
(43) Pub. Date: Apr. 28, 2016

(54) TRANSMITTING DATA THROUGH PARTIALLY AVAILABLE TIME SLOTS

(71) Applicant: QUALCOMM Incorporated, San Diego, CA (US)

(72) Inventors: Chien Chung LIN, San Diego, CA (US); Hari SANKAR, San Diego, CA (US); Tzu-Han CHOU, San Diego, CA (US); Thawatt GOPAL, San Diego, CA (US); Carlos Ruben CABRERA MERCADER, Cardiff by the Sea, CA (US); Insung KANG, San Diego, CA (US)

(21) Appl. No.: 14/631,451

(22) Filed: Feb. 25, 2015

Related U.S. Application Data
(60) Provisional application No. 62/069,738, filed on Oct. 28, 2014.

(51) Int. Cl. H04W 28/16; H04W 72/08; H04B 1/707; H04W 16/02

(52) U.S. Cl. CPC H04W 28/16; H04W 16/02; H04W 72/082; H04B 1/707

(57) ABSTRACT

Aspects include detecting, by a user equipment, an interference pattern that interferes with a transmission in a plurality of first time slots. Further included is determining a blanking pattern based on the temporal overlap between the interference pattern and the first time slots, and determining a partial time slot format for each partially overlapped one of the first time slots, wherein each partial time slot format includes code and pilot information from a non-overlapped section of each overlapped one of the first time slots. Additionally included is determining a code rate for each partial time slot based on each partial time slot format, determining a power boost for each partial time slot based on each code rate, and transmitting information in each partial time slot according to each partial time slot format and each corresponding code rate and at a transmit power associated with the corresponding power boost.

### CROSS-REFERENCE TO RELATED APPLICATIONS

This application claims priority to U.S. Provisional Application Ser. No. 62/069,738 entitled “TRANSMITTING DATA THROUGH PARTIALLY AVAILABLE TIME SLOTS,” filed Oct. 28, 2014, which is assigned to the assignee hereof and expressly incorporated by reference herein in its entirety.

### BACKGROUND

The present disclosure relates generally to wireless communication systems and, more particularly, to transmitting data through partially available time slots.

Wireless communication networks are widely deployed to provide various communication services such as telephony, video, data, messaging, broadcasts, and so on. The networks may be multiple access networks capable of supporting communications for multiple users by sharing the available network resources. An example of such a network is a Universal Terrestrial Radio Access Network (UTRAN). UTRAN is the Radio Access Network (RAN) that is part of the Universal Mobile Telecommunications System (UTMS), a third generation (3G) mobile phone technology promulgated by the “3rd Generation Partnership Project” (3GPP). UMTS, which is the successor to Global System for Mobile Communications (GSM), currently uses various standards including Wideband Code Division Multiple Access (WCDMA), High Speed Downlink Packet Data (HSDPA), Time Division-Code Division Multiple Access (TD-CDMA), and Time Division-Synchronous Code Division Multiple Access (TD-SCDMA). By way of example, China is pursuing TD-SCDMA as the underlying air interface in the UTRAN architecture with the existing GSM infrastructures for the core network. Another example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology.

As the demand for mobile broadband access continues to increase, there exists a need for further improvements in these wireless communication technologies.

For instance, data transmission by a wireless device during interference by another signal provides an opportunity for improvement. For example, when a wireless device is transmitting data, it may experience interference. Such interference may cause one or more transmission time slots to be partially unavailable and, as such, those time slots are not utilized. Therefore, improvements in transmitting data in the presence of interference are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method for wireless communication may include: detecting, by a user equipment, an interference pattern that interferes with a transmission in a plurality of first time slots on an uplink channel, wherein the interference pattern occupies a plurality of second time slots and wherein at least one of the plurality of second time slots temporally overlaps one of the plurality of first time slots; determining a blanking pattern based on the temporal overlap between the plurality of first time slots and the plurality of second time slots; determining a partial time slot format for each of the plurality of first time slots determined to partially overlap with one of the plurality of second time slots, wherein each partial time slot format includes code information and pilot information from a non-overlapped section of each overlapped one of the plurality of first time slots; determining a code rate for each partial time slot based on each partial time slot format; determining a power boost for each partial time slot based on each code rate; and transmitting information in each partial time slot according to each partial time slot format and each corresponding code rate and at a transmit power associated with the corresponding power boost.

In another aspect of the disclosure, an apparatus for wireless communication may include: an interference detector configured to detect an interference pattern that interferes with a transmission in a plurality of first time slots on an uplink channel, wherein the interference pattern occupies a plurality of second time slots and wherein at least one of the plurality of second time slots temporally overlaps one of the plurality of first time slots; a blanking pattern determiner configured to determine a blanking pattern based on the temporal overlap between the plurality of first time slots and the plurality of second time slots; a partial slot format determiner configured to determine a partial time slot format for each of the plurality of first time slots determined to partially overlap with one of the plurality of second time slots, wherein each partial time slot format includes code information and pilot information from a non-overlapped section of each overlapped one of the plurality of first time slots; a code rate determiner configured to determine a code rate for each partial time slot based on each partial time slot format; a power boost determiner configured to determine a power boost for each partial time slot based on each code rate; and a transmitting component configured to transmit information in each partial time slot according to each partial time slot format and each corresponding code rate and at a transmit power associated with the corresponding power boost.

In yet another aspect of the disclosure, an apparatus for wireless communication may include: means for detecting, by a user equipment, an interference pattern that interferes with a transmission in a plurality of first time slots on an uplink channel, wherein the interference pattern occupies a plurality of second time slots and wherein at least one of the plurality of second time slots temporally overlaps one of the plurality of first time slots; means for determining a blanking pattern based on the temporal overlap between the plurality of first time slots and the plurality of second time slots; means for determining a partial time slot format for each of the plurality of first time slots determined to partially overlap with one of the plurality of second time slots, wherein each partial time slot format includes code information and pilot information from a non-overlapped section of each overlapped one of the plurality of first time slots; means for determining a code rate for each partial time slot based on each partial time slot format; means for determining a power boost for each partial time slot based on each code rate; and means for transmitting information in each partial time slot according to each partial time slot format and each corresponding code rate and at a transmit power associated with the corresponding power boost.

In yet another aspect of the disclosure, a computer-readable medium storing computer executable code for wireless communication may include: code for detecting, by a user equipment, an interference pattern that interferes with a transmission in a plurality of first time slots on an uplink channel, wherein the interference pattern occupies a plurality of second time slots and wherein at least one of the plurality of second time slots temporally overlaps one of the plurality of first time slots; code for determining a blanking pattern based on the temporal overlap between the plurality of first time slots and the plurality of second time slots; code for determining a partial time slot format for each of the plurality of first time slots determined to partially overlap with one of the plurality of second time slots, wherein each partial time slot format includes code information and pilot information from a non-overlapped section of each overlapped one of the plurality of first time slots; code for determining a code rate for each partial time slot based on each partial time slot format; code for determining a power boost for each partial time slot based on each code rate; and code for transmitting information in each partial time slot according to each partial time slot format and each corresponding code rate and at a transmit power associated with the corresponding power boost.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional components or actions, and in which:

FIG. 1 is a conceptual diagram illustrating a wireless device in communication with a radio network.

FIG. 2 is a flowchart conceptually illustrating an example of a method of transmitting data through partially available time slots.

FIG. 3 is a conceptual diagram illustrating an example of time slot overlap in a channel.

FIG. 4 is a conceptual diagram illustrating an example of various time slot formats.

FIG. 5 is a conceptual diagram illustrating an example of a hardware implementation for an apparatus employing a processing system.

FIG. 6 is a conceptual diagram illustrating an example of a channel structure in a telecommunications system.

FIG. 7 is a conceptual diagram illustrating an example of a telecommunications system.

FIG. 8 is a conceptual diagram illustrating an example of an access network.

FIG. 9 is a conceptual diagram illustrating an example of a NodeB in communication with a UE in a telecommunications system.

### DETAILED DESCRIPTION

The detailed description set forth below, in connection with the appended drawings, is intended as a description of various configurations and is not intended to represent the sole configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. Moreover, the term “component” as used herein may be one of the parts that make up a system, may be hardware or software or some combination thereof, and may be divided into other components.

According to an aspect, a wireless device, for example, a user equipment (UE) or access terminal (AT), may perform partial slot transmission in the presence of interference in another portion of the slot. In one example, but not limited hereto, this technique may improve the utilization of shared uplink (UL) radio resource for TD-SCDMA when the transmitter of the wireless device is subjected to transmission interruption in the time domain. As such, partial slot transmission may address the problems associated with Dual Subscriber Identity Module (SIM) Dual Active (DSDA) single transmit scenarios as well as other scenarios, such as when an external source, such as a signal jammer, interferes with the transmissions of the wireless device. In these scenarios, UL time slots may be interrupted and become partially or completely unavailable (e.g., undergo blanking, where blanking defines the interrupted portion of the time slot), thus causing degradation in UL performance.

Given sufficient resolution regarding UL operation within the interrupted time slot, the present aspects may utilize the partially available portion of the time slot (e.g., partial slots) to transmit extra data. For different blanking occurrences, different partial time slot formats may be used. Also, for transmission time intervals (TTIs) containing partial time slots, the present aspects may implement different combinations of code rate and boost-up power to achieve regular full slot transmission performance.

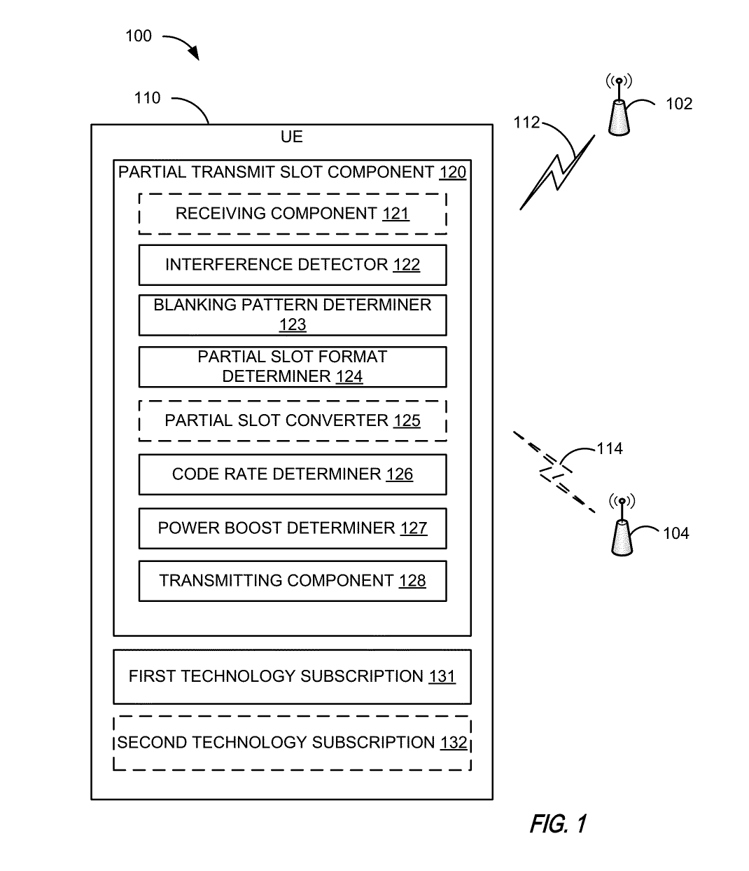

Referring to FIG. 1, in an aspect, a wireless communication system 100 includes a user equipment (UE) 110 having a partial transmit slot component 120 configured to transmit data through partially available time slots. The UE 110 may also include a first technology subscription 131 that is configured to allow UE 110 to transmit signals via transmitting component 128 using a first radio access technology 112, such as but not limited to TD-SCDMA. The UE 110 may communicate using the first technology subscription 131 with another device, such as base station or Node B 102 using the first radio access technology 112. During transmission using the first technology subscription 131, the UE 110 may experience interference from another source, such as an internal source that uses a second radio access technology 114 or from an external source of a same or different technology. For instance, when UE 110 shares transmitting component 128, the interference source may be a second technology subscription 132 that is configured to transmit signals using a second radio access technology 114, such as Global System for Mobile Communications (GSM). For example, in some aspects, UE 110 may need to cause transmitting component 128 to tune away from transmissions using first technology subscription 131 and instead transmit using second technology subscription 132. In this case, one or more of a second plurality of time slots associated with transmissions using second technology subscription 132 may partially and/or fully temporally overlap one or more of a first plurality of time slots associated with transmissions using first technology subscription 131. Further, for instance, the interference source may also be an external device 104, which may transmit a signal referred to as a jammer, e.g., any signal that disrupts communications by the UE 110.

The partial transmit slot component 120 may include a number of components that facilitate transmission of data through time slots that are only partially available due to the presence of interference. For example, the partial transmit slot component 120 may include an optional receiving component 121, an interference detector 122, a blanking pattern determiner 123, a partial slot format determiner 124, an optional partial slot converter 125, a code rate determiner 126, a power boost determiner 127, and a transmitting component 128.

The optional receiving component 121 may be configured to receive data for transmission during one of more of the first plurality of time slots associated with transmissions using first technology subscription 131. The receiving component 121 may include an interface to a data source and/or to a flow of data for transmission, and also may include a buffer or memory for storing such data. In an aspect, for example, the receiving component 121 may include a protocol layer entity at one hierarchical layer that interfaces with another protocol layer entity at a higher protocol layer.

The interference detector 122, which may be coupled to the transmitting component 128, may be configured to detect an interference pattern with respect to one of more of the first plurality of time slots associated with transmissions using first technology subscription 131. For example, the interference detector 122 may detect an actual or a scheduled disruption of first radio access technology transmissions. For instance, the interference detector 122 may detect such interference by detecting, for example, an increased signal to noise ratio of the communications in the first time slots, e.g., such as from an external signal, or whole or partial interruption (e.g., temporal overlap, blanking) of the first time slots by second time slots associated with the second radio access technology 114.

Once the interference detector 122 detects the interference pattern and determines that at least one of the corresponding second plurality of time slots of the interference pattern at least partially overlaps one or more of the first time slots of the first radio access technology 112, the blanking pattern determiner 123 may determine a blanking pattern (e.g., interference pattern with respect to, or remaining non-overlapped portions of, the plurality of first time slots). The blanking pattern may thereby indicate which of the plurality of first time slots are partial slots, full slots, or blanked out slots. For example, in these aspects, a partial slot is one of the plurality of first time slots that is partially overlapped by the interference pattern; a full slot is one of plurality of the first time slots that is not overlapped by the interference pattern (and hence not blocked or blanked out); and a blanked out slot is one of plurality of the first time slots that is fully overlapped by the interference pattern. The blanking pattern may thereby control which of the plurality of first time slots is to be converted to a partial time slot for transmission.

The partial slot format determiner 124 may determine a partial time slot format for ones of the plurality of first time slots that partially overlap with the interference pattern (which may be defined by the plurality of second time slots). The partial time slot format for a particular first time slot may be based on an amount by which the interference pattern, or a second time slot, overlaps the particular first time slot.

Optionally, the partial slot converter 125 may convert an otherwise partially blanked, and hence previously unused, first time slot to a partial time slot based on the partial time slot format. The partial time slot may include a portion of the first data from a section of a respective first time slot that the interference pattern, or a respective second time slot, does not overlap.

The code rate determiner 126 may determine a code rate based on the partial time slot format. The code rate may be defined as k/n, inversely reflecting the degree of redundancy introduced by additional symbols that are transmitted. For example, if the code rate is k/n, for every k bits of useful information, a total of n bits of data are generated, of which n-k are redundant. In an aspect, the code rate determiner 126 may reduce the original code rate of transmission in order to preserve the effective code rate of the partial time slot.

The power boost determiner 127 may determine a power boost based on the code rate. The power boost may be a transmit power value, or an adjustment value to apply to an existing transmit power value, configured to increase a transmission power of the partial time slot.

The different combinations of code rate and power boost allow the partial time slot to achieve regular full slot transmission performance and facilitate decoding of the partial time slot on the network side (e.g., at the base station 102).

The transmitting component 128 may be configured to transmit data. The transmitting component 170 may include a transmitter. In an aspect, the transmitting component 128 may include a transceiver shared with the receiving component 121. The transmitting component 128 may transmit the partial time slot at the code rate and transmit power associated with the power boost. The transmitting component 170 may be used to transmit any other information in the uplink direction as needed.

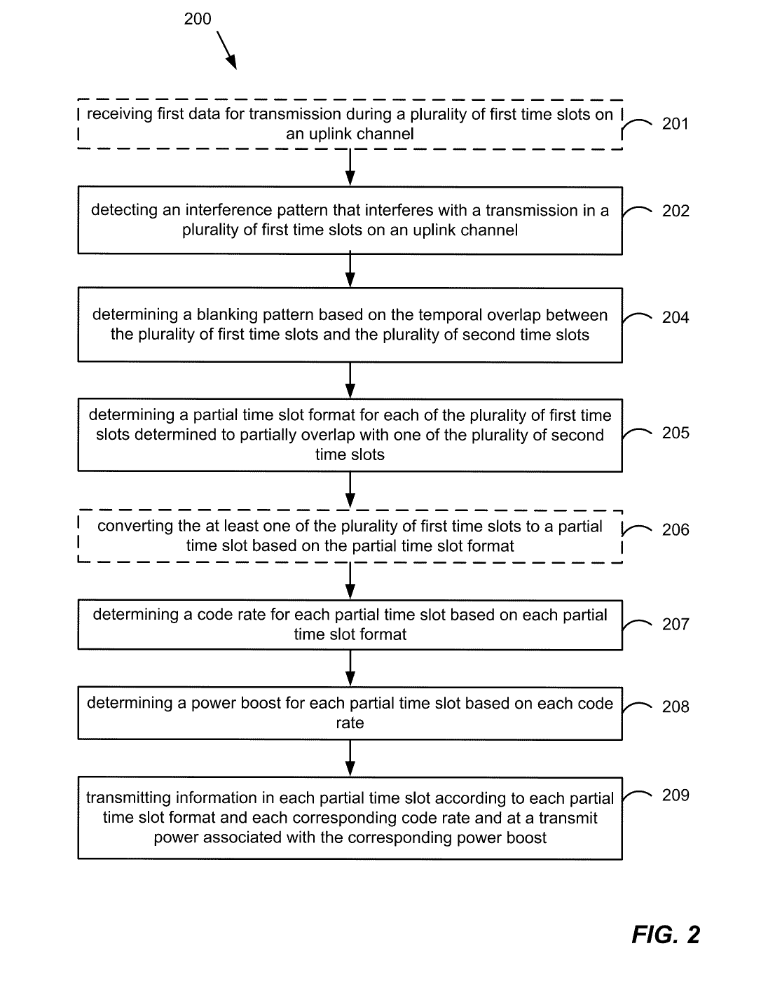

FIG. 2 is a flowchart illustrating a method 200 of transmitting data through partially available time slots. Referring to FIG. 1, in an operational aspect, a UE 110 may perform various aspects of a method 200, such as through execution of partial time slot component 120. While, for purposes of simplicity of explanation, the method is shown and described as a series of acts, it is to be understood and appreciated that the method (and further methods related thereto) is/are not limited by the order of acts, as some acts may, in accordance with one or more aspects, occur in different orders and/or concurrently with other acts from that shown and described herein. For example, it is to be appreciated that a method could alternatively be represented as a series of interrelated states or events, such as in a state diagram. Moreover, not all illustrated acts may be required to implement a method in accordance with one or more features described herein. Moreover, it should be understood that the following actions or functions may be performed by a specially-programmed processor, a processor executing specially-programmed software or computer-readable media, or by any other combination of a hardware component and/or a software component capable of performing the described actions or functions.

In an aspect, at block 201, the method 200 optionally may include receiving first data for transmission during a plurality of first time slots on an uplink channel. For example, in an aspect, the partial transmit slot component 120 and/or receiving component 121 may receive data associated with a first technology subscription 131 for transmission during a plurality of first time slots on an uplink channel via the transmitting component 128.

In block 202, the method 200 may include detecting an interference pattern that interferes with a transmission in a plurality of first time slots on an uplink channel, wherein the interference pattern occupies a plurality of second time slots and wherein at least one of the plurality of second time slots temporally overlaps one of the plurality of first time slots. For example, in an aspect, partial transmit slot component 120 and/or the interference detector 122 may detect an interference with first radio access technology transmissions 112 that occupy first time slots by an interference pattern that at least partially overlaps with at least one of the first time slots. In some cases, for example, the interference pattern may be from actual or scheduled (e.g., based on a tune away schedule) second radio access technology transmissions 114 that occupy second time slots. In other cases, the interference pattern may be from an external signal received by UE 110.

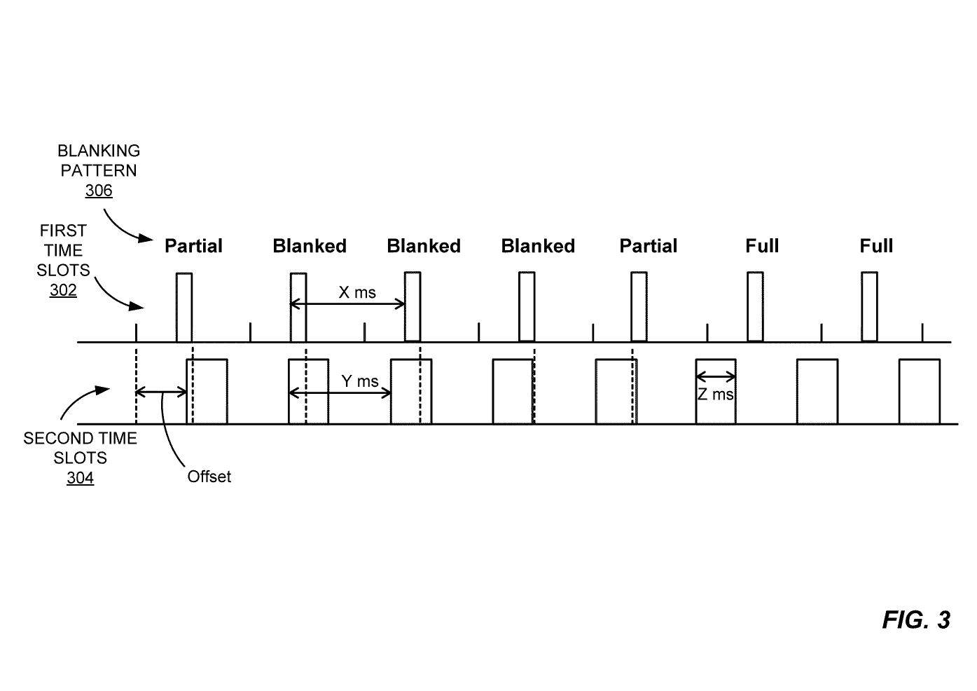

For example, in an aspect, the interference detector 122 may detect that the second time slots of the second radio access technology 114 completely or partially overlap one or more the first time slots. For example, as shown in FIG. 3, one or more of the first time slots 302 may be overlapped by a respective one or more of the second time slots 304, thereby defining blanking pattern 306. In blanking pattern 306, partially overlapped ones of the first time slots are designated as “partial,” completely overlapped ones of the first time slots are designated as “blanked,” and non-overlapped ones of the first time slots that are designated as “full.”

In block 204, the method 200 may include determining a blanking pattern based on the temporal overlap between the plurality of first time slots and the plurality of second time slots. For example, in an aspect, partial transmit slot component 120 and/or blanking pattern determiner 123 may determine a blanking pattern based on the temporal overlap between the plurality of first time slots and the plurality of second time slots. For instance, in an aspect, the blanking pattern determiner 123 may determine a blanking pattern of the first time slots, indicating which first time slots are partial slots, full slots, and blanked out slots.

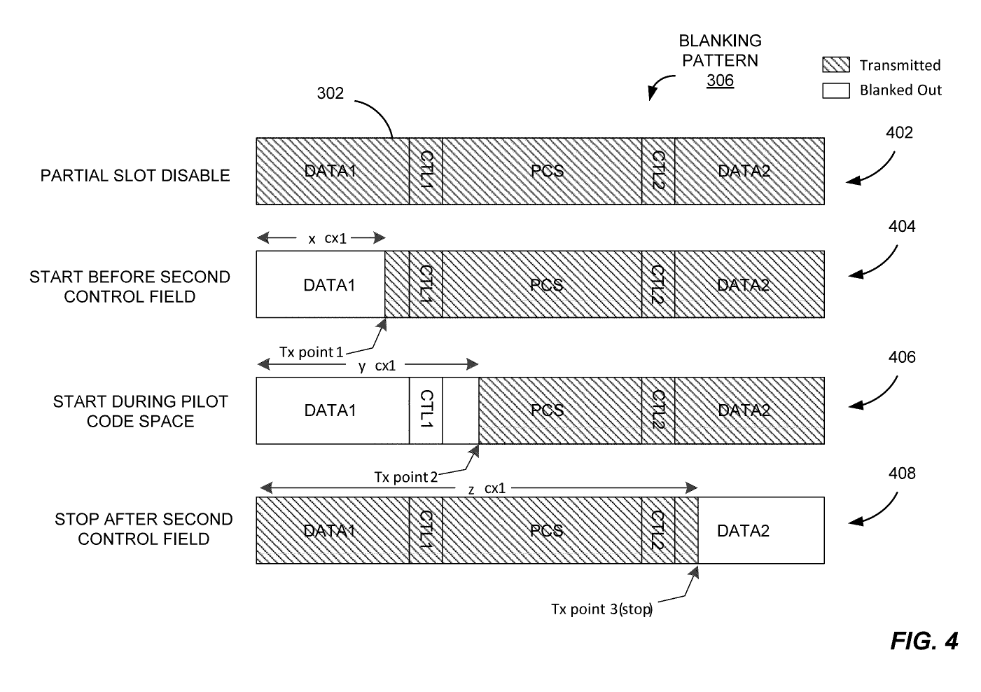

In block 205, the method 200 may include determining a partial time slot format for each of the plurality of first time slots determined to partially overlap with one of the plurality of second time slots, wherein each partial time slot format includes code information and pilot information from a non-overlapped section of each overlapped one of the plurality of first time slots. For example, in an aspect, partial transmit slot component 120 and/or the partial slot format determiner 124 may determine a partial time slot format for the first time slots that partially overlap with the second time slots. For different blanking occurrences, different partial time slot formats may be used. The partial time slot format for a particular first time slot may be based on an amount by which a second time slot overlaps the particular first time slot. For example, as shown in FIG. 4, a representative first time slot 302 may include a number of fields: a first data field DATA1 that may be configured to carry a data payload; a first control field CTL1, which may be a code word or a Transport Format Combination Indicator (TFCI) that informs a designated receiver of the transport format; a pilot field, which may be a pilot code space PCS or a midamble configured to carry pilot information; a second control field CTL2; and a second data field DATA2. The partial time format may be disabled when it is determined that the first time slot is not being overlapped by the second time slot, e.g., a “full” slot 402.

In an aspect, to signal use of and a capability to support different types of partial slots to the network (e.g., base station 102), the partial slot format determiner 124 may add to the first or second control field (e.g., control word or TFCI) an indication of the type of partial slot format used by the partial time slot to facilitate decoding the format at the network. This indication may be added in addition to the rate control information already present in the control fields. In an aspect, the indication may be added as a user equipment (UE) capability information. In another aspect, the indication may be included in the first and/or second control field or an additional field in the time slot 302 as an indication of support of partial slot for 1.28 Mcps time division duplex (TDD) physical channel capability.

As shown in FIG. 4, in an aspect, the partial time slot format may be configured to permit transmission of data from the first control field, the pilot field, the second control field, the second data field, and a segment of the first data field when at least one of the plurality of second time slots partially overlaps the first data field. For example, the partial time slot format 404 may permit the transmission of the first time slot to begin at a point within the first data field (e.g., 256x chips after the start of the first time slot, where x is an integer).

As shown in FIG. 4, in an aspect, the partial time slot format may be configured to permit transmission of data from the second control field, the second data field, and a portion of the pilot field when at least one of the plurality of second time slots overlaps the first data field, the first control field, and a segment of the pilot field. For example, the partial time slot format 406 may permit the transmission of the first time slot to begin at a point within the pilot field (e.g., y chips after the start of the first time slot, where x is an integer).

As shown in FIG. 4, in an aspect, the partial time slot format may be configured to permit transmission of data from the first data field, first control field, the pilot field, the second control field, and a segment of the second data field when at least one of the plurality of second time slots partially overlaps the second data field. For example, the partial time slot format 408 may permit the transmission of the first time slot to end at a point within the second data field (e.g., z chips after the start of the first time slot).

Returning to FIG. 2, as shown in block 206, the method 200 may optionally include converting the at least one of the plurality of first time slots to a partial time slot based on the partial time slot format. For example, partial time slot transmit component 120 and/or the optional partial slot converter 125 may convert the first time slots that have been assigned a partial time slot format to a partial time slot based on the partial time slot format. The partial time slot may include a portion of the first data from a section of the first time slot that the second time slot does not overlap. In an aspect the partial slot converter 125 may zero out the chips in the portion of the first time slot that is overlapped by the second time slot. For example, as shown in FIG. 4, the partial slot converter 125 may zero out the chips of the portion of the partial time slot that is blanked out. In an aspect, the partial slot converter 125 may instruct the transmitting component 128 to not transmit the portion of the first time slot that is overlapped by the second time slot. In an aspect, the recipient of the partial time slot (e.g., NodeB 102) may receive noise for the blanked out portion of the partial time slot.

In block 207, the method 200 may include determining a code rate for each partial time slot based on each partial time slot format. For example, in an aspect, the partial slot transmit component and/or the code rate determiner 126 may determine a code rate based on the partial time slot format. For transmission time intervals (TTIs) containing partial time slots, aspects may implement different combinations of code rate and power boost (e.g., boost-up power) to allow the partial time slot to achieve the same block error rate (BLER) performance as a regular full time slot transmission. The maximum code rate allowed may be subjected to the determined blanking pattern as well as the TTI length and channel type.

In block 208, the method 200 may include determining a power boost for each partial time slot based on each code rate. For example, in an aspect, the partial slot transmit component and/or the power boost determiner 127 may determine a power boost based on the code rate. The power boost may be configured to increase a transmission power of the partial time slot by a magnitude that may be directly proportional to a value of the code rate.

In block 209, the method 200 may include transmitting information in each partial time slot according to each partial time slot format and each corresponding code rate and at a transmit power associated with the corresponding power boost. For example, in an aspect, the partial slot transmit component and/or the transmitting component 128 may transmit the partial time slot at the code rate and transmit power associated with the power boost.

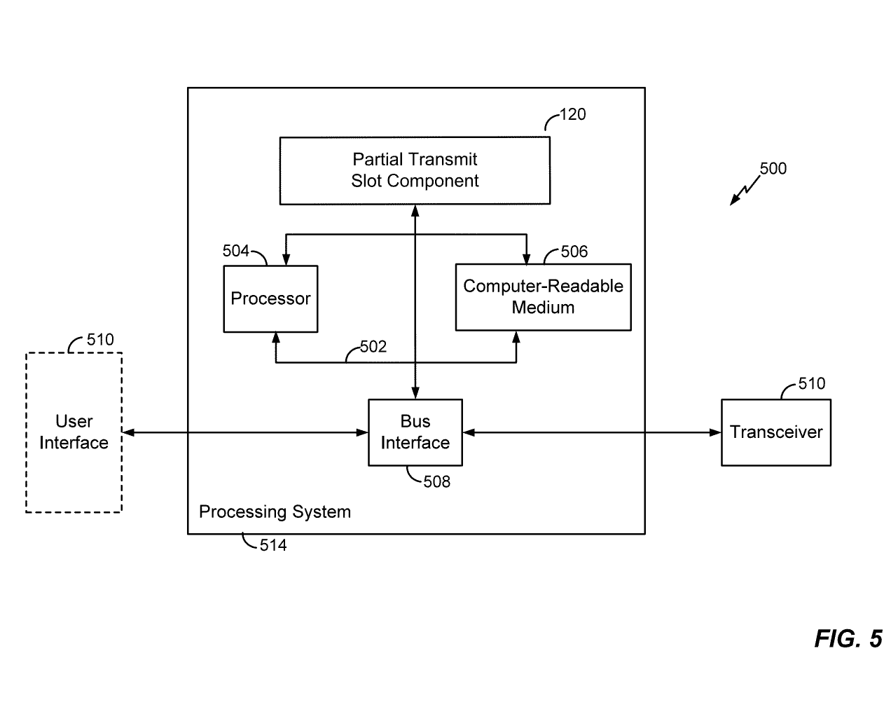

FIG. 5 is a conceptual diagram illustrating an example of a hardware implementation for an apparatus 500 employing a processing system 514 that includes partial slot transmit component 120 for transmitting information in partial slots. The apparatus 500 may correspond to the UE 110 (FIG. 1) and include a partial transmit slot component 120 for transmitting data through partially available time slots. In this example, the processing system 514 may be implemented with a bus architecture, represented generally by the bus 502. The bus 502 may include any number of interconnecting buses and bridges depending on the specific application of the processing system 514 and the overall design constraints. The bus 502 links together various circuits including one or more processors, represented generally by the processor 504, and computer-readable media, represented generally by the computer-readable medium 506. The bus 502 also may link partial transmit slot component 120 to processor 504, and computer-readable medium 506. The bus 502 may also link various other circuits such as timing sources, peripherals, voltage regulators, and power management circuits, which are well known in the art, and therefore, will not be described any further. A bus interface 508 provides an interface between the bus 502 and a transceiver 510. The transceiver 510 provides a means for communicating with various other apparatus over a transmission medium. Depending upon the nature of the apparatus, a user interface 512 (e.g., keypad, display, speaker, microphone, joystick) may also be provided.

The processor 504 is responsible for managing the bus 502 and general processing, including the execution of software stored on the computer-readable medium 506. The software, when executed by the processor 504, causes the processing system 514 to perform the various functions described infra for any particular apparatus. The computer-readable medium 506 may also be used for storing data that is manipulated by the processor 504 when executing software.

In an aspect, the partial transmit slot component 120 may be implemented by software or computer-executable codes stored in computer-readable medium and executed on processor 504, and/or by processor modules within processor 504.

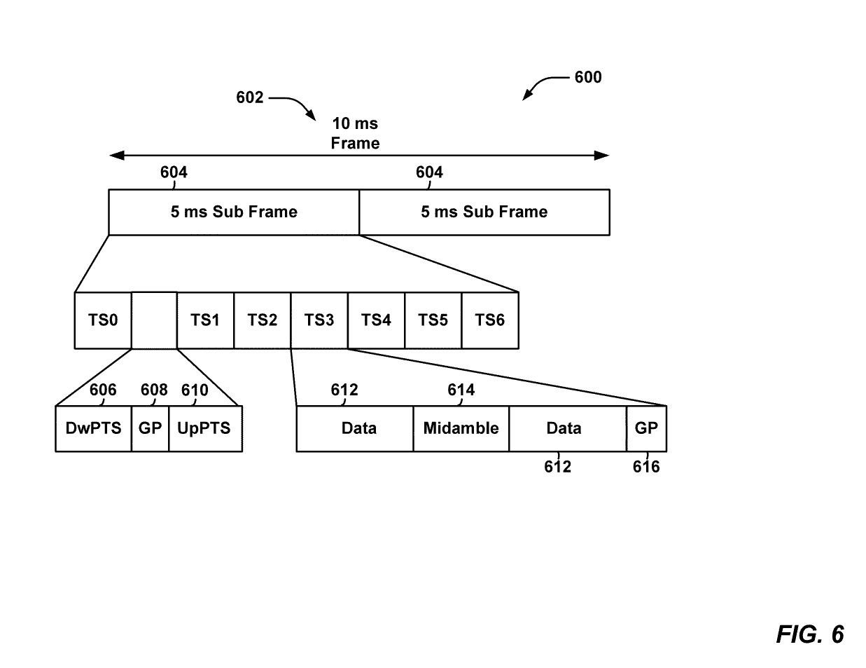

FIG. 6 shows the channel structure 600 for a TD-SCDMA carrier which may be used by UE 110 in executing partial slot transmit component 120. The carrier has a TD-SCDMA frame 602 that is 10 ms in length. The TD-SCDMA frame 602 is made up of two 5 ms subframes 604, and each subframe 604 is made up of seven time slots TS0 through TS6. The first time slot is TS0 and the last time slot is TS6. The first time slot, TS0, is for DL only. The second time slot, TS1, is for UL only. The remaining time slots TS2 through TS6 may be utilized for UL or DL, which can provide for flexibility. Between TS0 and TS1, there are three special timeslots, which include a DL pilot time slot (DwPTS) 606, a guard period (GP) 608, and a UL pilot time slot (UpPTS) 610 (also known as the UL pilot channel (UpPCH)). Each time slot TS0-TS6 includes two separate data portions 612 separated by a midamble 614 and followed by a guard period (GP) 616. The midamble 614 may be used for channel estimation and the GP 616 may be used to avoid inter-burst interference.

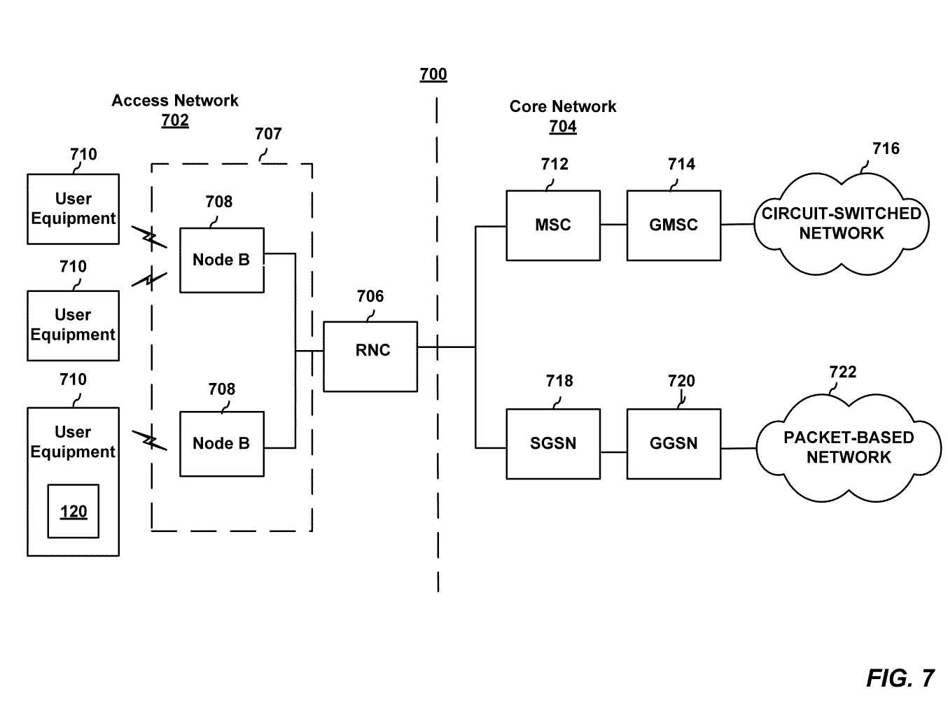

FIG. 7 is a conceptual diagram illustrating an example of a telecommunications system that may include a UE 710, which may be the same as or similar to UE 110, executing partial slot transmit component 120. Various concepts presented throughout this disclosure may be utilized across a broad array of telecommunication systems, network architectures and communication standards. One non-limiting example will now be presented with reference to a UMTS system employing a TD-SCDMA standard. In this example, the UMTS system includes a radio access network (RAN) 702 (e.g., UTRAN) that provides various wireless services including telephony, video, data, messaging, broadcasts, and/or other services. The RAN 702 may be divided into a number of Radio Network Subsystems (RNS), each controlled by a Radio Network Controller (RNC). Only one RNC 706 is shown for illustrative purposes, however, the RAN 702 may include any number of RNCs. The RNC 706 is an apparatus responsible for, among other things, assigning, reconfiguring and releasing radio resources within the RNS. The RNC 706 may be interconnected to other RNCs in the RAN 702 through an interface comprising a direct physical connection or a virtual network using any suitable transport network.

The geographic region covered by the RNS may be divided into a number of cells, with a radio transceiver apparatus serving each cell. The radio transceiver apparatus is commonly referred to as a NodeB in UMTS applications, but may also be referred to by those skilled in the art as a base station, a base transceiver station, a radio base station, a radio transceiver, a transceiver function, a basic service set (BSS), an extended service set (ESS), or some other suitable terminology. Two NodeBs 708 are shown for illustrative purposes, however, the RNS may include any number of wireless NodeBs 708. The NodeBs 708 provide wireless access points to a core network 704 for any number of mobile apparatuses. Examples of a mobile apparatuses include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For illustrative purposes, three UEs 710 are shown in communication with the NodeBs 708.

The core network 704 is shown as a GSM core network. However, as those skilled in the art will recognize, the various concepts presented throughout this disclosure may be implemented in a RAN, or other suitable access network, to provide UEs with access to other core networks.

In this example, the core network 704 supports circuit-switched services with a Mobile Switching Center (MSC) 712 and a Gateway MSC (GMSC) 714. One or more RNCs may be connected to the MSC 712. The MSC 712 is an apparatus that controls call setup, call routing, and UE mobility functions. The MSC 712 also includes a Visitor Location Register (VLR) (not shown) that contains subscriber related information for the duration that a UE is in the coverage area of the MSC 712. The GMSC 714 provides a gateway for the UE to a Public Switched Telephone Network (PSTN) 716. The GMSC 714 includes a Home Location Register (HLR) (not shown) which contains subscriber data, such as the details of the services to which a user has subscribed. Associated with an HLR is an Authentication Center (AuC) that contains subscriber specific authentication data. The GMSC 714 is responsible for querying the HLR when a call is received for a UE to determine its location and for forwarding the call to the MSC serving that location.

The core network 704 also supports packet-data services with a Serving GPRS Support Node (SGSN) 718 and a Gateway GPRS Support Node (GGSN) 720. GPRS, which stands for General Packet Radio Service, is designed to provide packet-data services at higher speeds than those available with standard GSM circuit-switched data services. The GGSN 720 provides a connection for the RAN 702 to a packet-based network 722. The packet-based network 722 may be the Internet, a private data network, or some other suitable packet-based network. The primary function of the GGSN 720 is to provide the UEs 710 with network connectivity. Data packets are transferred between the GGSN 720 and the UEs 710 through the SGSN 718, which performs primarily the same functions in the packet-based domain as the MSC 712 performs in the circuit-switched domain.

The UMTS air interface is a Direct-Sequence Code Division Multiple Access (DS-CDMA) system. DS-CDMA means that user data is spread over a much wider bandwidth through multiplication by a sequence of pseudorandom bits called chips. The TD-SCDMA standard calls for a Time Division Duplex (TDD) system. TDD systems use the same carrier for both the uplink (UL) and downlink (DL) between a NodeB 708 and a UE 710. The duplexing is based on time and not frequency, as is done typically with Frequency Division Duplex (FDD).

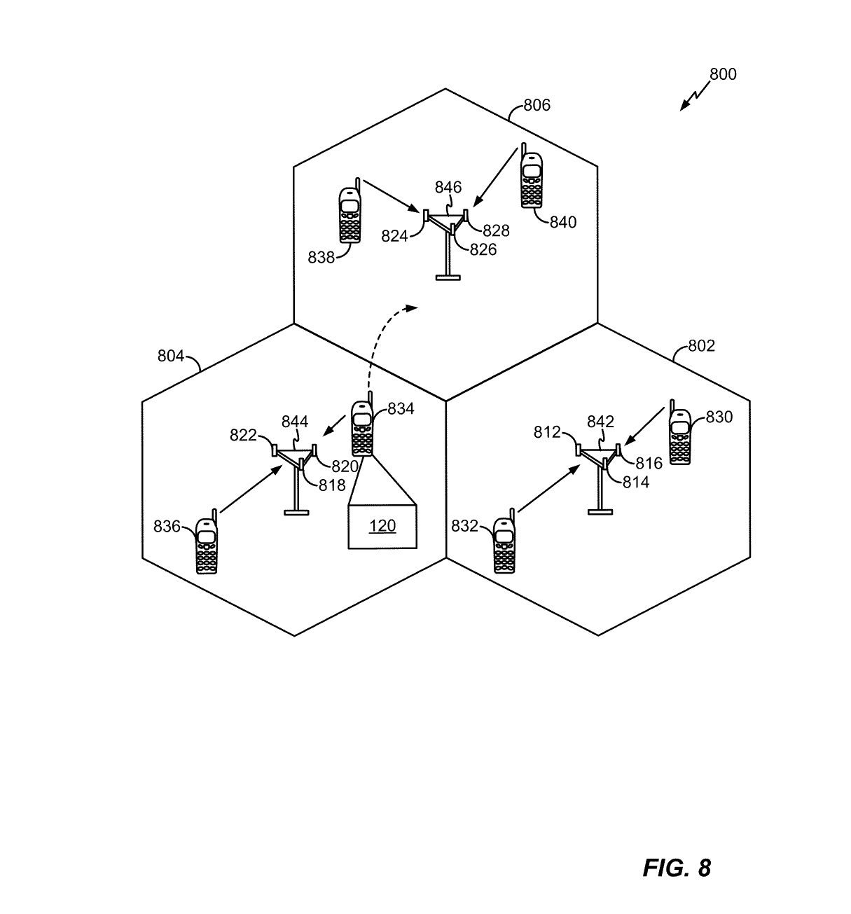

Referring to FIG. 8, an access network 800 in a UTRAN architecture is illustrated that may include a UE 834, which may be the same as or similar to UE 110, executing partial slot transmit component 120. The access network 800 may provide wireless communication access for UEs 830, 832, 834, 836, 838, 840, which may each be an example of the UE 110 in FIG. 1. The multiple access wireless communication system includes multiple cellular regions (cells), including cells 802, 804, and 806, each of which may include one or more sectors. The multiple sectors can be formed by groups of antennas with each antenna responsible for communication with UEs in a portion of the cell. For example, in cell 802, antenna groups 812, 814, and 816 may each correspond to a different sector. In cell 804, antenna groups 818, 820, and 822 each correspond to a different sector. In cell 806, antenna groups 824, 826, and 828 each correspond to a different sector. The cells 802, 804 and 806 may include several wireless communication devices, e.g., User Equipment or UEs, which may be in communication with one or more sectors of each cell 802, 804 or 806. For example, UEs 830 and 832 may be in communication with Node B 842, UEs 834 and 836 may be in communication with Node B 844, and UEs 838 and 840 can be in communication with Node B 846. Here, each Node B 842, 844, 846 is configured to provide an access point to a core network 704 (see FIG. 7) for all the UEs 830, 832, 834, 836, 838, 840 in the respective cells 802, 804, and 806.

As the UE 834 moves from the illustrated location in cell 804 into cell 806, a serving cell change (SCC) or handover may occur in which communication with the UE 834 transitions from the cell 804, which may be referred to as the source cell, to cell 806, which may be referred to as the target cell. Management of the handover procedure may take place at the UE 834, at the Node Bs corresponding to the respective cells, at a radio network controller 706 (see FIG. 7), or at another suitable node in the wireless network. For example, during a call with the source cell 804, or at any other time, the UE 834 may monitor various parameters of the source cell 804 as well as various parameters of neighboring cells such as cells 806 and 802. Further, depending on the quality of these parameters, the UE 834 may maintain communication with one or more of the neighboring cells. During this time, the UE 834 may maintain an Active Set, that is, a list of cells that the UE 834 is simultaneously connected to (e.g., the UTRA cells that are currently assigning a downlink dedicated physical channel DPCH or fractional downlink dedicated physical channel F-DPCH to the UE 834 may constitute the Active Set).

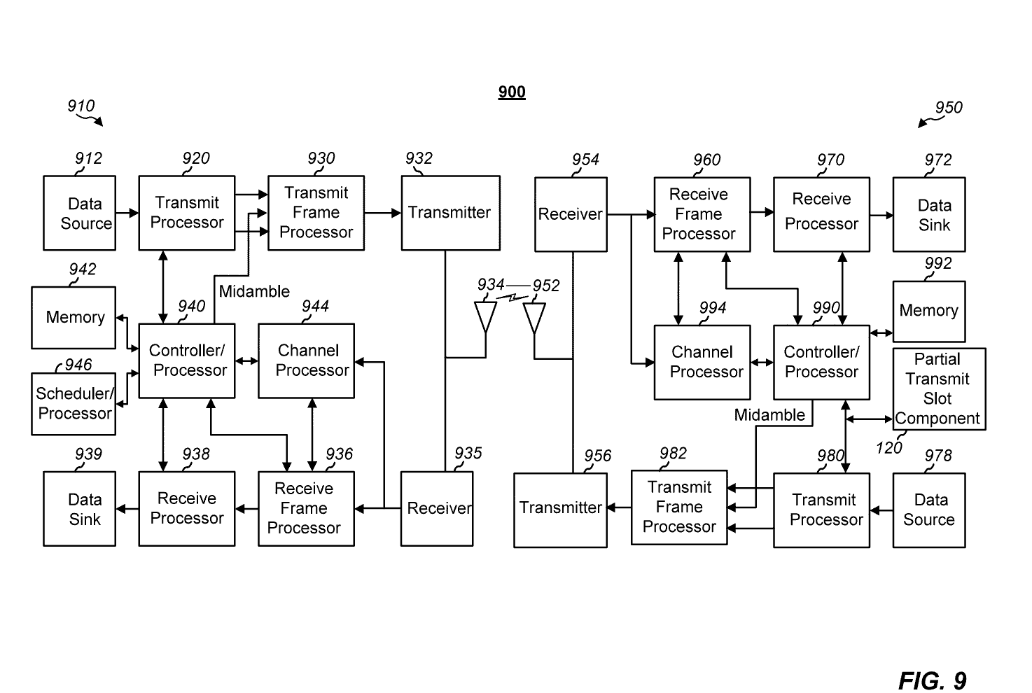

FIG. 9 is a block diagram of a NodeB 910 in communication with a UE 950 in a RAN, where UE 950 may be the same as or similar to UE 110, including partial slot transmit component 120. In the DL, a transmit processor 920 may receive data from a data source 912 and control signals from a controller/processor 940. The transmit processor 920 provides various signal processing functions for the data and control signals, as well as reference signals (e.g., pilot signals). By way of example, the transmit processor 920 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)), spreading with Orthogonal Variable Spreading Factors (OVSF), and multiplying with scrambling codes to produce a series of symbols. Channel estimates from a channel processor 944 may be used by a controller/processor 940 to determine the coding, modulation, spreading, and/or scrambling schemes for the transmit processor 920. The channel estimates may be derived from a reference signal transmitted by the UE 950 or feedback contained in the midamble from the UE 950. The symbols generated by the transmit processor 920 may be provided to a transmit frame processor 930 to create a channel structure by multiplexing the symbols with a midamble from the controller/processor 940 to create a series of frames. The frames may then be provided to a transmitter 932, which provides various signal conditioning functions including amplification, filtering, and modulating the frames onto a carrier for DL transmission over the wireless medium through smart antennas 934. The smart antennas 934 may be implemented with beam steering bidirectional adaptive antenna arrays.

At the UE 950, a receiver 954 receives the DL transmission through an antenna 952 and processes the transmission to recover the information modulated onto the carrier. The information recovered by the receiver 954 is provided to a receive frame processor 960. The receive frame processor 960 parses each frame, and provides the midamble to a channel processor 994 and the data, control, and reference signals to a receive processor 970. The receive processor 970 performs the inverse processing done by the transmit processor 920 in the NodeB 910. More specifically, the receive processor 970 descrambles and despreads the symbols, and then determines the most likely signal constellation points transmitted by the NodeB 910 based on the modulation scheme. These soft decisions may be based on channel estimates computed by the channel processor 994. The soft decisions are then decoded and deinterleaved to recover the data, control and reference signals. The CRCs are then checked to determine whether the frames were successfully decoded. The data carried by the successfully decoded frames may be provided to a data sink 972. The data sink 972 represents applications running in the UE 950 and various user interfaces (e.g., display). Control signals carried by successfully decoded frames may be provided to a controller/processor 990. The controller/processor 990 may also use an acknowledgement (ACK) and/or negative acknowledgement (NACK) protocol to support retransmission requests for frames that were unsuccessfully decoded by the receive processor 970.

In the UL, data from a data source 978 and control signals from the controller/processor 990 are provided to a transmit processor 980. The data source 978 may represent applications running in the UE 950 and various user interfaces (e.g., keyboard). Similar to the functionality described in connection with the DL transmission by the NodeB 910, the transmit processor 980 provides various signal processing functions including CRC codes, coding and interleaving to facilitate FEC, mapping to signal constellations, spreading with OVSFs, and scrambling to produce a series of symbols. Channel estimates derived by the channel processor 994 from a reference signal transmitted by the NodeB 910 or feedback contained in the midamble transmitted by the NodeB 910 may be used to select the appropriate coding, modulation, spreading and/or scrambling schemes. The symbols produced by the transmit processor 980 may be provided to a transmit frame processor 982 to create a channel structure by multiplexing the symbols with a midamble from the controller/processor 990 to create a series of frames. The frames may then be provided to a transmitter 956, which provides various signal conditioning functions including amplification, filtering, and modulating the frames onto a carrier for UL transmission over the wireless medium through the antenna 952. The partial transmit slot component 120 may further process the frames based on a blanking pattern, partial time slot format, a code rate, and a power boost to ensure proper transmission of partial time slots. The partial transmit slot component 120 may be implemented by various components of the transmit chain including the transmitter 956, transmit frame processor 982 and the transmit processor 980.

The UL transmission is processed at the NodeB 910 in a manner similar to that described in connection with the receiver function at the UE 950. A receiver 935 receives the UL transmission through the antenna 934 and processes the transmission to recover the information modulated onto the carrier. The information recovered by the receiver 935 is provided to a receive frame processor 936. The receive frame processor 936 parses each frame, and provides the midamble to the channel processor 944 and the data, control, and reference signals to a receive processor 938. The receive processor 938 performs the inverse processing done by the transmit processor 920 in the NodeB 910. The data carried by the successfully decoded frames may be provided to a data sink 939. Control signals carried by successfully decoded frames may be provided to the controller/processor 940. The controller/processor 940 may also use a acknowledgement (ACK) and/or negative acknowledgement (NACK) protocol to support retransmission requests for frames that were unsuccessfully decoded by the receive processor 938.

The controller/processors 940 and 990 may be used to direct the operation at the NodeB 910 and the UE 950, respectively. By way of example, the controller/processors 940 and 990 may provide various functions including timing, peripheral interfaces, voltage regulation, power management, and other control functions. Memories 942 and 992 may store data and software for the NodeB 910 and the UE 950, respectively. A scheduler/processor 946 at the NodeB 910 may be used to allocate resources to the UEs and schedule DL and/or UL transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as WCDMA, HSPA and TD-CDMA. Various aspects may also be extended to systems employing Long Term Evolution (LTE), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field programmable gate array (FPGA), a programmable logic device (PLD), a state machine, gated logic, discrete hardware circuits, and other suitable processing component configured to perform the various functions described throughout this disclosure. The functionality of a processor, any portion of a processor, or any combination of processors presented in this disclosure may be implemented with software being executed by a microprocessor, microcontroller, DSP, or other suitable platform. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various embodiments presented throughout this disclosure, the memory may be internal to the processors (e.g., cache or register). A computer-readable medium may also include a carrier wave, a transmission line, or any other suitable medium for storing or transmitting software. Computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication, comprising:
detecting, by a user equipment, an interference pattern that interferes with a transmission in a plurality of first time slots on an uplink channel, wherein the interference pattern occupies a plurality of second time slots and wherein at least one of the plurality of second time slots temporally overlaps one of the plurality of first time slots;
determining a blanking pattern based on the temporal overlap between the plurality of first time slots and the plurality of second time slots;
determining a partial time slot format for each of the plurality of first time slots determined to partially overlap with one of the plurality of second time slots, wherein each partial time slot format includes code information and pilot information from a non-overlapped section of each overlapped one of the plurality of first time slots;
determining a code rate for each partial time slot based on each partial time slot format;
determining a power boost for each partial time slot based on each code rate; and
transmitting information in each partial time slot according to each partial time slot format and each corresponding code rate and at a transmit power associated with the corresponding power boost.

2. The method of claim 1, wherein each partial time slot format is based on an amount by which a respective one of the plurality of second time slots overlaps a respective one of the plurality of first time slots.

3. The method of claim 1, wherein the blanking pattern includes a partial time slot and at least one of a full slot and a blanked out slot, wherein the full slot includes one of the first time slots that does not overlap with one of the second time slots, and wherein the blanked out slot includes one of the first time slots that fully overlaps with one of the second time slots.

4. The method of claim 1, wherein each of the plurality of first time slots includes a first data field, a first control field configured to carry the control information, a pilot field configured to carry the pilot information, a second control field configured to carry the control information, and a second data field.

5. The method of claim 4, wherein the partial time slot format is configured to permit transmission of data from the first control field, the pilot field, the second control field, the second data field, and a segment of the first data field when at least one of the plurality of second time slots partially overlaps the first data field.

6. The method of claim 4, wherein the partial time slot format is configured to permit transmission of data from the second control field, the second data field, and a portion of the pilot field when at least one of the plurality of second time slots overlaps the first data field, the first control field, and a segment of the pilot field.

7. The method of claim 4, wherein the partial time slot format is configured to permit transmission of data from the first data field, first control field, the pilot field, the second control field, and a segment of the second data field when at least one of the plurality of second time slots partially overlaps the second data field.

8. The method of claim 1, further comprising signaling, to a network, user equipment (UE) capability information including an indication of a capability to support the partial time slot format.

9. The method of claim 8, wherein the power boost is configured to increase a transmission power of the partial time slot.

10. The method of claim 1, wherein the first time slot is a Global System for Mobile Communications (GSM) time slot.

11. The method of claim 1, wherein the second time slot is a Time Division-Synchronous Code Division Multiple Access (TD-SCDMA) time slot.

12. The method of claim 1, wherein determining the blanking pattern further comprises determining where the plurality of second time slots temporally overlap with the plurality of first time slots.

13. The method of claim 1, wherein the interference pattern is generated by the user equipment.

14. The method of claim 1, wherein the interference pattern is generated by an external signal source.

15. An apparatus for wireless communication, comprising:
an interference detector configured to detect an interference pattern that interferes with a transmission in a plurality of first time slots on an uplink channel, wherein the interference pattern occupies a plurality of second time slots and wherein at least one of the plurality of second time slots temporally overlaps one of the plurality of first time slots;
a blanking pattern determiner configured to determine a blanking pattern based on the temporal overlap between the plurality of first time slots and the plurality of second time slots;
a partial slot format determiner configured to determine a partial time slot format for each of the plurality of first time slots determined to partially overlap with one of the plurality of second time slots, wherein each partial time slot format includes code information and pilot information from a non-overlapped section of each overlapped one of the plurality of first time slots;
a code rate determiner configured to determine a code rate for each partial time slot based on each partial time slot format;
a power boost determiner configured to determine a power boost for each partial time slot based on each code rate; and
a transmitting component configured to transmit information in each partial time slot according to each partial time slot format and each corresponding code rate and at a transmit power associated with the corresponding power boost.

16. The apparatus of claim 15, wherein each partial time slot format is based on an amount by which a respective one of the plurality of second time slots overlaps a respective one of the plurality of first time slots.

17. The apparatus of claim 15, wherein the blanking pattern includes a partial time slot and at least one of a full slot and a blanked out slot, wherein the full slot includes one of the first time slots that does not overlap with one of the second time slots, and wherein the blanked out slot includes one of the first time slots that fully overlaps with one of the second time slots.

18. The apparatus of claim 15, wherein each of the plurality of first time slots includes a first data field, a first control field configured to carry the control information, a pilot field configured to carry the pilot information, a second control field configured to carry the control information, and a second data field.

19. The apparatus of claim 18, wherein the partial time slot format is configured to permit transmission of data from the first control field, the pilot field, the second control field, the second data field, and a segment of the first data field when at least one of the plurality of second time slots partially overlaps the first data field.

20. The apparatus of claim 18, wherein the partial time slot format is configured to permit transmission of data from the second control field, the second data field, and a portion of the pilot field when at least one of the plurality of second time slots overlaps the first data field, the first control field, and a segment of the pilot field.

21. The apparatus of claim 18, wherein the partial time slot format is configured to permit transmission of data from the first data field, first control field, the pilot field, the second control field, and a segment of the second data field when at least one of the plurality of second time slots partially overlaps the second data field.

22. The apparatus of claim 15, wherein the partial slot format determiner is further configured to signal, to a network, user equipment (UE) capability information including an indication of a capability to support the partial time slot format.

23. The apparatus of claim 22, wherein the power boost is configured to increase a transmission power of the partial time slot.

24. The apparatus of claim 15, wherein the first time slot is a Global System for Mobile Communications (GSM) time slot.

25. The apparatus of claim 15, wherein the second time slot is a Time Division-Synchronous Code Division Multiple Access (TD-SCDMA) time slot.

26. The apparatus of claim 15, wherein the blanking pattern determiner is further configured to determine where the plurality of second time slots temporally overlap with the plurality of first time slots.

27. The apparatus of claim 15, wherein the interference pattern is generated by the user equipment.

28. The apparatus of claim 15, wherein the interference pattern is generated by an external signal source.

29. An apparatus for wireless communication, comprising:
means for detecting, by a user equipment, an interference pattern that interferes with a transmission in a plurality of first time slots on an uplink channel, wherein the interference pattern occupies a plurality of second time slots and wherein at least one of the plurality of second time slots temporally overlaps one of the plurality of first time slots;
means for determining a blanking pattern based on the temporal overlap between the plurality of first time slots and the plurality of second time slots;
means for determining a partial time slot format for each of the plurality of first time slots determined to partially overlap with one of the plurality of second time slots, wherein each partial time slot format includes code information and pilot information from a non-overlapped section of each overlapped one of the plurality of first time slots;
means for determining a code rate for each partial time slot based on each partial time slot format;
means for determining a power boost for each partial time slot based on each code rate; and
means for transmitting information in each partial time slot according to each partial time slot format and each corresponding code rate and at a transmit power associated with the corresponding power boost.

30. The apparatus of claim 29, wherein each partial time slot format is based on an amount by which a respective one of the plurality of second time slots overlaps a respective one of the plurality of first time slots.

31. The apparatus of claim 29, wherein the blanking pattern includes a partial time slot and at least one of a full slot and a blanked out slot, wherein the full slot includes one of the first time slots that does not overlap with one of the second time slots, and wherein the blanked out slot includes one of the first time slots that fully overlaps with one of the second time slots.

32. The apparatus of claim 29, wherein each of the plurality of first time slots includes a first data field, a first control field configured to carry the control information, a pilot field configured to carry the pilot information, a second control field configured to carry the control information, and a second data field.

33. The apparatus of claim 32, wherein the partial time slot format is configured to permit transmission of data from the first control field, the pilot field, the second control field, the second data field, and a segment of the first data field when at least one of the plurality of second time slots partially overlaps the first data field.

34. The apparatus of claim 32, wherein the partial time slot format is configured to permit transmission of data from the second control field, the second data field, and a portion of the pilot field when at least one of the plurality of second time slots overlaps the first data field, the first control field, and a segment of the pilot field.

35. The apparatus of claim 32, wherein the partial time slot format is configured to permit transmission of data from the first data field, first control field, the pilot field, the second control field, and a segment of the second data field when at least one of the plurality of second time slots partially overlaps the second data field.

36. The apparatus of claim 29, further comprising means for signaling, to a network, user equipment (UE) capability information including an indication of a capability to support the partial time slot format.

37. The apparatus of claim 36, wherein the power boost is configured to increase a transmission power of the partial time slot.

38. The apparatus of claim 29, wherein the first time slot is a Global System for Mobile Communications (GSM) time slot.

39. The apparatus of claim 29, wherein the second time slot is a Time Division-Synchronous Code Division Multiple Access (TD-SCDMA) time slot.

40. The apparatus of claim 29, wherein the means for determining the blanking pattern is further for determining where the plurality of second time slots temporally overlap with the plurality of first time slots.

41. The apparatus of claim 29, wherein the interference pattern is generated by the user equipment.

42. The apparatus of claim 29, wherein the interference pattern is generated by an external signal source.

43. A computer-readable medium storing computer executable code for wireless communication, comprising:
code for detecting, by a user equipment, an interference pattern that interferes with a transmission in a plurality of first time slots on an uplink channel, wherein the interference pattern occupies a plurality of second time slots and wherein at least one of the plurality of second time slots temporally overlaps one of the plurality of first time slots;
code for determining a blanking pattern based on the temporal overlap between the plurality of first time slots and the plurality of second time slots;
code for determining a partial time slot format for each of the plurality of first time slots determined to partially overlap with one of the plurality of second time slots, wherein each partial time slot format includes code information and pilot information from a non-overlapped section of each overlapped one of the plurality of first time slots;
code for determining a code rate for each partial time slot based on each partial time slot format;
code for determining a power boost for each partial time slot based on each code rate; and
code for transmitting information in each partial time slot according to each partial time slot format and each corresponding code rate and at a transmit power associated with the corresponding power boost.

44. The computer-readable medium of claim 43, wherein each partial time slot format is based on an amount by which a respective one of the plurality of second time slots overlaps a respective one of the plurality of first time slots.

45. The computer-readable medium of claim 43, wherein the blanking pattern includes a partial time slot and at least one of a full slot and a blanked out slot, wherein the full slot includes one of the first time slots that does not overlap with one of the second time slots, and wherein the blanked out slot includes one of the first time slots that fully overlaps with one of the second time slots.

46. The computer-readable medium of claim 43, wherein each of the plurality of first time slots includes a first data field, a first control field configured to carry the control information, a pilot field configured to carry the pilot information, a second control field configured to carry the control information, and a second data field.

47. The computer-readable medium of claim 46, wherein the partial time slot format is configured to permit transmission of data from the first control field, the pilot field, the second control field, the second data field, and a segment of the first data field when at least one of the plurality of second time slots partially overlaps the first data field.

48. The computer-readable medium of claim 46, wherein the partial time slot format is configured to permit transmission of data from the second control field, the second data field, and a portion of the pilot field when at least one of the plurality of second time slots overlaps the first data field, the first control field, and a segment of the pilot field.

49. The computer-readable medium of claim 46, wherein the partial time slot format is configured to permit transmission of data from the first data field, first control field, the pilot field, the second control field, and a segment of the second data field when at least one of the plurality of second time slots partially overlaps the second data field.

50. The computer-readable medium of claim 43, further comprising code for signaling, to a network, user equipment (UE) capability information including an indication of a capability to support the partial time slot format.

51. The computer-readable medium of claim 50, wherein the power boost is configured to increase a transmission power of the partial time slot.

52. The computer-readable medium of claim 43, wherein the first time slot is a Global System for Mobile Communications (GSM) time slot.

53. The computer-readable medium of claim 43, wherein the second time slot is a Time Division-Synchronous Code Division Multiple Access (TD-SCDMA) time slot.

54. The computer-readable medium of claim 43, wherein the code for determining the blanking pattern is further for determining where the plurality of second time slots temporally overlap with the plurality of first time slots.

55. The computer-readable medium of claim 43, wherein the interference pattern is generated by the user equipment.

56. The computer-readable medium of claim 43, wherein the interference pattern is generated by an external signal source.
